(19) United States
(12) Patent Application Publication
(10) Pub. No.: US 2026/0298408 A1
(43) Pub. Date: Oct. 1, 2026

(54) UNIVERSAL STABILIZING SYSTEM

(71) Applicant: Ascend Aerials, LLC, Atlanta, GA (US)

(72) Inventor: Louie Northern, Atlanta, GA (US)

(73) Assignee: Ascend Aerials, LLC, Atlanta, GA (US)

(21) Appl. No.: 19/578,559

(22) Filed: Mar. 25, 2026

Related U.S. Application Data
(60) Provisional application No. 63/777,347, filed on Mar. 25, 2025.

(51) Int. Cl. F16M 13/02; G03B 17/56

(52) U.S. Cl. CPC F16M 13/022; G03B 17/561; F16M 2200/04

(57) ABSTRACT

A universal stabilization system for balancing multiple payloads is provided. The stabilization system includes up to five motor assemblies and three link members. The stabilization system may be connected to a payload frame that can accommodate multiple payloads. When one or more payloads are coupled to the universal stabilization system, the universal stabilization system is disposed at the center of gravity while the one or more payloads are disposed along a periphery of the universal stabilization system. One of the three link members is a rectangular hollow box that couples to the other two link members. The other two link members couple to a rotor of one of the five motor assemblies. The rest of the four motor assemblies are also coupled to the rectangular hollow box.

### CROSS-REFERENCE TO RELATED APPLICATIONS

This application claims priority to U.S. Provisional Application No. 63/777,347, titled UNIVERSAL STABILIZING SYSTEM FOR CAMERAS, filed Mar. 25, 2025, which is hereby incorporated by reference in its entirety.

### FIELD OF INVENTION

The present disclosure relates generally to stabilizing solutions for cameras or pointing devices. Specifically, the embodiments of the present disclosure are related to universal stabilizing systems for one or more payload devices.

### BACKGROUND

Conventional stabilizing solutions such as gimbals are designed to place the payload (e.g., a camera) on the exact center of gravity (CG) of the apparatus in order to maintain balanced operation. In these conventional systems, the payload of a gimbal is physically balanced across the X, Y, and Z axis (e.g., for Pan, Tilt, and Roll), and this balance is essential to effective stabilization of any gimbal. Typically, this balance is accomplished by the apparatus having multiple cantilevered members which encompass a payload such that they can manipulate the payload's position across all three axes into active stabilization. However, such stabilization apparatus is extremely hard to scale to accommodate multiple cameras due to its complexity and other limitations related to construction or material integrity.

In a filming environment, it may be necessary to balance and operate multiple cameras (e.g., up to 20) at the same time. The traditional balancing systems cannot effectively accommodate such a large number of cameras. Therefore, there is a need for a versatile stabilizing solution for multiple cameras and/or other payloads that is easy to operate and provides a robust balancing solution.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Embodiments of the present disclosure provide a universal stabilization system that includes a first motor assembly, a first link member that is coupled to the first motor assembly, a second link member that is coupled to the first motor assembly, a third link member, a second motor assembly that is coupled to the first link member, a third motor assembly that is coupled to the second link member, a fourth motor assembly that is coupled to the third link member, and a fifth motor assembly that is coupled to the third link member.

Other embodiments of the present disclosure provide a system that includes a stabilization assembly and a payload frame that is coupled to the stabilization assembly. The stabilization assembly may further include a first motor assembly, a first link member that is coupled to the first motor assembly, a second link member that is coupled to the first motor assembly, a third link member, a second motor assembly that is coupled to the first link member, a third motor assembly that is coupled to the second link member, a fourth motor assembly that is coupled to the third link member, and a fifth motor assembly that is coupled to the third link member.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIGS. 1A and 1B illustrate different views of a universal stabilization system according to an embodiment of the present disclosure.

FIGS. 2A-2F illustrate various views of a partial stabilization assembly according to an embodiment of the present disclosure.

FIG. 3 illustrates details of the third link member according to an embodiment of the present disclosure.

FIGS. 4A-4E illustrate camera mounting system configurations according to various embodiments of the present disclosure.

FIGS. 5A-5E illustrate the operation of the universal stabilization system according to an embodiment of the present disclosure.

FIG. 6 illustrates a universal stabilization system that includes a power management system according to an embodiment of the present disclosure.

FIG. 7 illustrates how the power and communication distribution unit is connected to each of the payloads attached to the universal stabilization system according to an embodiment of the present disclosure.

FIGS. 8A-8G illustrate various environments in which the universal stabilization system may be used according to embodiments of the present disclosure.

FIG. 9A illustrates a universal stabilization system assembly that includes one or more slip rings according to an embodiment of the present disclosure.

FIG. 9B illustrates details of the slip ring assembly according to an embodiment of the present disclosure.

The drawings are provided for purposes of illustration only and merely depict example embodiments of the disclosure. The drawings are provided to facilitate understanding of the disclosure and shall not be deemed to limit the breadth, scope, or applicability of the disclosure. The use of the same reference numerals indicates similar, but not necessarily the same or identical components. Different reference numerals may be used to identify similar components. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

As noted above, traditional camera stabilization techniques such as using gimbals may need to have several cantilevered members to accommodate multiple cameras. Such systems are hard to scale to accommodate a large number of cameras, due to their structural and operational complexity and due to the strength integrity limitations of traditional materials and construction. These traditional systems can get very heavy and cumbersome to operate when more than one camera or any other payload needs to be used concurrently.

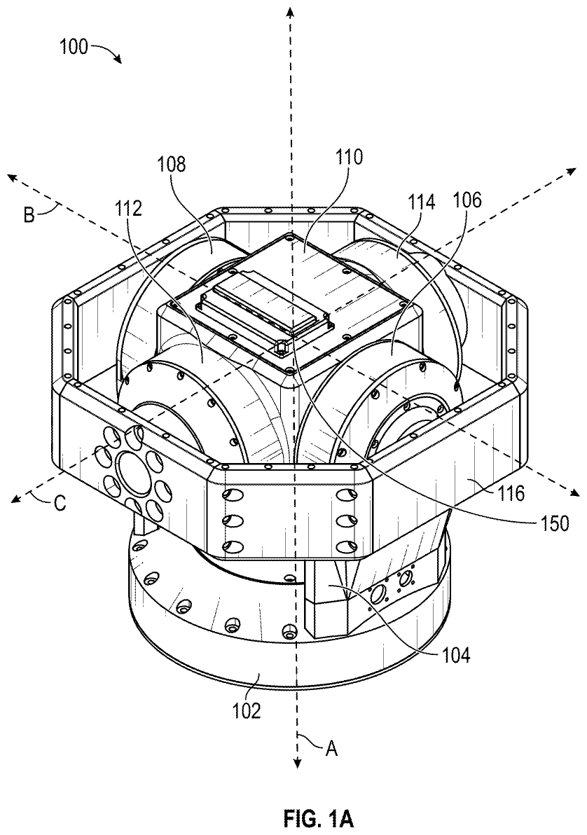

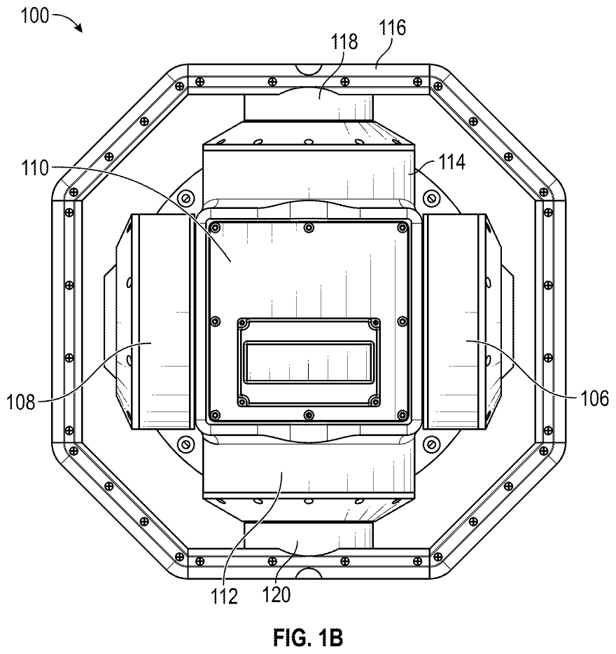

FIGS. 1A and 1B illustrate different views of a universal stabilization system 100 according to an embodiment of the present disclosure. The universal stabilization system 100 includes a first motor assembly 102 that includes a first motor and a system mount. The system mount is configured to attach the motor to an external system such as a platform or some other device that may hold the cameras during operation of the cameras. The first motor is configured to rotate around a vertical axis ‘A’. In an embodiment, the stator of the first motor is connected to the system mount, which in turn is connected to a complementary connector of the external system. The rotor of the first motor is connected to two link members and may include a slip ring (not shown). A first link member 104a is connected to the rotor of the first motor at a first connection point and a second link member 104b is connected to the rotor of the first motor at a second connection point. Both the first link member 104a and the second link member 104b are static and are located opposite each other. Each of the first link member 104a and the second link member 104b rise vertically from the rotor of the first motor. In an embodiment, the first link member 104a is coupled to a second motor assembly 106 and the second link member 104b is coupled to a third motor assembly 108. In an embodiment, the first motor may be referred to as a pan motor.

In an embodiment, the second motor assembly 106 may include a second motor and a second stator and the third motor assembly 108 may include a third motor and a third stator. The first link member 104a is coupled to the second stator of the second motor assembly and the second link member is coupled to the third stator of the third motor assembly 108. In an embodiment, the second motor and the third motor are each configured to rotate around a roll axis ‘B’ that is orthogonal to the axis A. The universal stabilizing system 100 includes a third link member 110. A first surface of the third link member 110 is coupled to the second rotor of the second motor assembly 106 and a second surface of the third link member 110 is coupled to the third rotor of the third motor assembly 108. The universal stabilizing system 100 further includes a fourth motor assembly 112 and a fifth motor assembly 114. The fourth motor assembly 112 includes a fourth rotor and a fourth stator and the fifth motor assembly 114 includes a fifth rotor and a fifth stator. In an embodiment, the fourth stator is coupled to a third surface of the third link member 110 and the fifth stator is coupled to a fourth surface of the third link member 110. In an embodiment, the third link member 110 may be rectangular in shape. In other embodiments, the third link member may be of other polygonal or non-polygonal shapes. In an embodiment, the fourth motor and the fifth motor are each configured to rotate around a tilt axis ‘C’, which is orthogonal to both the axes A and B. The center of gravity of the universal stabilization system 100 is at a point 150 where the three axes A, B, and C meet.

In an embodiment, the universal stabilization system 100 may also include a fourth link member 116. The fourth link member 116 may be composed of one or more individual link members joined together. In an embodiment, the fourth rotor of the fourth motor assembly 112 may be connected to an external payload, such as a camera. The fifth rotor of the fifth motor assembly 114 may also be connected to an external payload. In an embodiment, the second motor assembly 106, the third motor assembly 108 may be referred to as a roll motor assembly. The fourth motor assembly 112, and the fifth motor assembly 114 may each be referred to as a tilt motor assembly. Each of the second motor assembly 106 and the third motor assembly 108 enables a roll motion of the attached payload around the respective axis. Each of the fourth motor assembly 112, and the fifth motor assembly 114 enables a tilt motion of the attached payload around the respective axis. In an embodiment, the fourth link member 116 is coupled with the fifth motor assembly 114 at a first connection point 118. The fourth link member 116 may also be coupled with the fourth motor assembly 112 at a second connection point 120. In an embodiment, the first connection point 118 may be placed opposite to the second connection point 120. In another embodiment, the fourth link member 116 is never coupled with the second motor assembly 106 or the third motor assembly 108, as illustrated in FIG. 1B. In an embodiment, the axis A passes equidistantly between the second motor assembly 106 and the third motor assembly 108 and also equidistantly between the fourth motor assembly 112 and the fifth motor assembly 114. In an embodiment, the axis B passes equidistantly between the fourth motor assembly 112 and the fifth motor assembly 114 and the axis C passes equidistantly between the second motor assembly 106 and the third motor assembly 108. In an embodiment, the first motor, the second motor, the third motor, the fourth motor and the fifth motor are all slot-less motors. Slot-less motors are electric motors that do not have traditional stator slots. Instead of having iron-core slots to hold the stator windings, slot-less motors have windings placed in an air-gap or distributed on a smooth stator surface. In some embodiments, the first motor, the second motor, the third motor, the fourth motor and the fifth motor may all be slot-less motors with a center opening. These slot-less motors are specialized electric motors that combine the benefits of a slot-less design with a hollow or open center. This configuration allows for unique applications where space in the center may be needed for optics, wiring, fluid flow, slip rings, or other components.

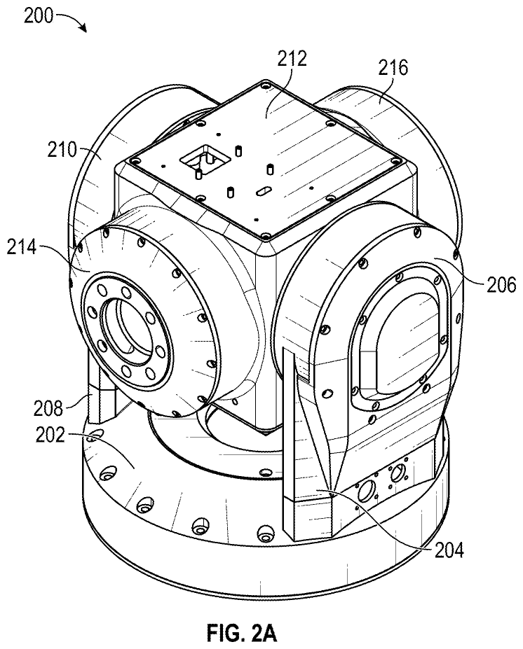

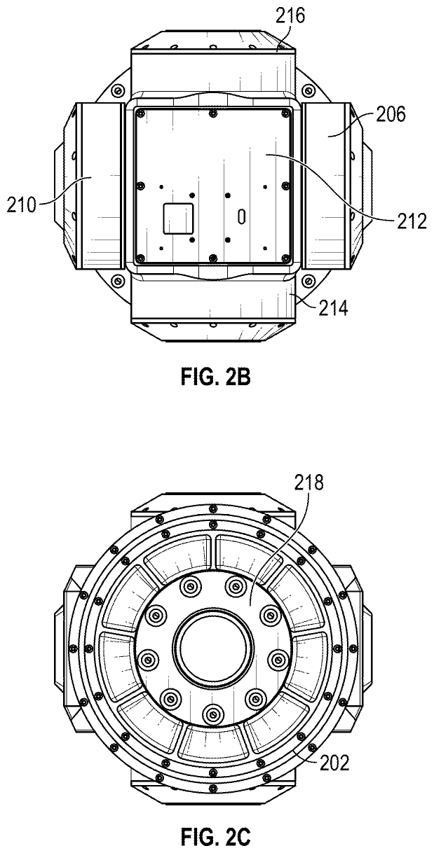

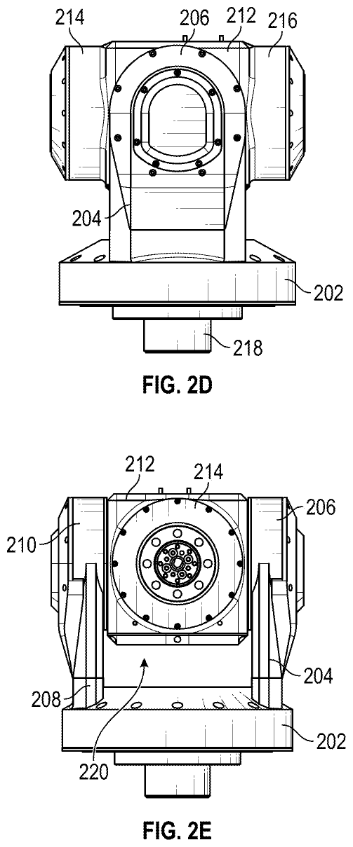

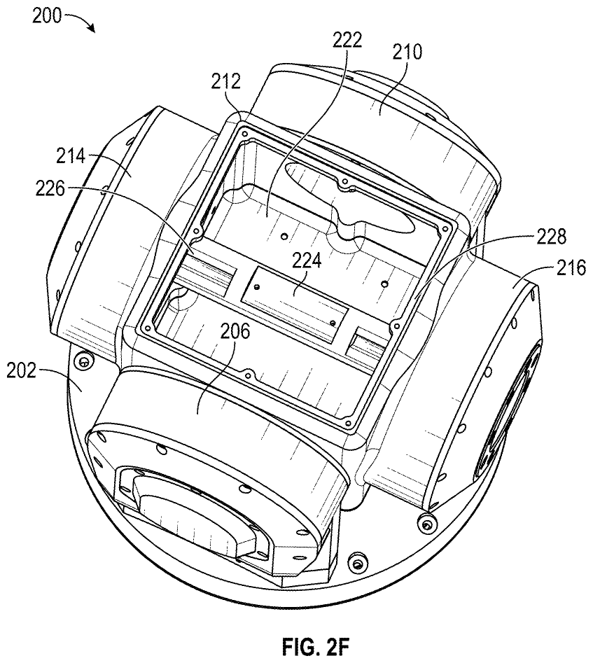

FIGS. 2A-2F illustrate various views of a partial universal stabilization assembly 200 according to an embodiment of the present disclosure. The partial universal stabilization assembly 200 is part of the universal stabilization system 100. The partial universal stabilization assembly 200 includes a first motor assembly 202, a second motor assembly 206, a third motor assembly 210, a fourth motor assembly 214 and a fifth motor assembly 216. The partial universal stabilization assembly 200 also includes a first link member 204, a second link member 208, and a third link member 212. The first motor assembly 202 includes a first rotor and a first stator. The first rotor of the first motor assembly 202 is coupled with a system mount (not shown). The system mount may be part of a larger mechanical structure that also holds one or more payloads (e.g., cameras). The first link member 204 and the second link member 208 are coupled to the first rotor of the first motor assembly 202. The first rotor of the first motor assembly is configured to rotate around a first axis (e.g., axis A of FIG. 1). The first link member 204 and the second link member 208 are disposed around a periphery of the first motor and are located opposite to each other. The second motor assembly 206 includes a second rotor and a second stator. The first link member 204 is rigidly coupled to the second stator of the second motor assembly 206. The third motor assembly 210 includes a third rotor and a third stator. The second link member 208 is rigidly coupled to the third stator of the third motor assembly 210.

The second rotor of the second motor assembly 206 is coupled to a first surface of the third link member 212. The third rotor of the third motor assembly 210 is coupled to a second surface of the third link member 212. In an embodiment, the first surface of the third link member 212 is opposite to the second surface of the third link member 212. The third link member 212 also includes a third surface and an opposing fourth surface. The fourth motor assembly 214 includes a fourth stator and a fourth rotor. The fifth motor assembly 216 includes a fifth stator and a fifth rotor. In an embodiment, a first housing of the fourth motor assembly 214 is coupled to the third surface of the third link member 212 and a second housing of the fifth motor assembly 216 is coupled to the fourth surface of the third link member 212. In an embodiment, the third link member 212 is coupled to the first motor assembly 202 only via the first link member 204 and the second link member 208. There is no direct connection between the third link member 212 and the first motor assembly 202. In other words, there is an opening 220 between the third link member 212 and the first motor assembly 202, as illustrated in FIG. 2E. The first motor assembly 202 may also include a connection member 218 that allows the first motor assembly 202 to be rigidly coupled to the system mount. Due to the manner in which the third link member 212 is coupled to the second motor assembly 206 and the third motor assembly 210, the third link member is 212 is free to rotate freely along an axis (e.g., axis B of FIG. 1) when no payload is connected to the universal stabilization assembly 200. In an embodiment, the third link member 212 may be cuboid in shape. In other embodiments, the third link member 212 may be spherical or polygonal in shape.

In an embodiment, the third link member 212 may define a chamber 222 that may house the electronics and other control circuitry for operating the first motor assembly 202, the second motor assembly 206, the third motor assembly 210, the fourth motor assembly 214, and the fifth motor assembly 216. In addition, the chamber 222 may also house an axle 224 that connects the fourth stator of the fourth motor assembly 214 with the fifth stator of the fifth motor assembly 216. The axle 224 is connected to the fourth stator at a first connection point 226 and to the fifth stator at a second connection point 228, as illustrated in FIG. 2F. Thus, in this embodiment, only the first housing of the fourth motor assembly 214 and the second housing of the fifth motor assembly 216 is coupled to the third link member 212, while the axle 224 connects the fourth stator with the fifth stator. The fourth motor and the fifth motor may be coupled to a payload mount that can accept one or more payloads. The axle 224 provides a rigid connection between the fourth stator and the fifth stator. In addition, the partial universal stabilization assembly 200 may include a slip ring (not shown) coupled to the axle 224 or may include multiple slip rings. For example, one slip ring each may be coupled to the first motor, the fourth motor, and the fifth motor. In other embodiments, each of the motors may have a corresponding slip ring coupled to it. The slip ring may house one or more sensors and other electronics used to control the various motors. In another embodiment, the axle may not be required as long as the fourth motor and the fifth motor can operate in sync with each other. The presence of the axle 224 ensures synchronized motion between the fourth motor and the fifth motor.

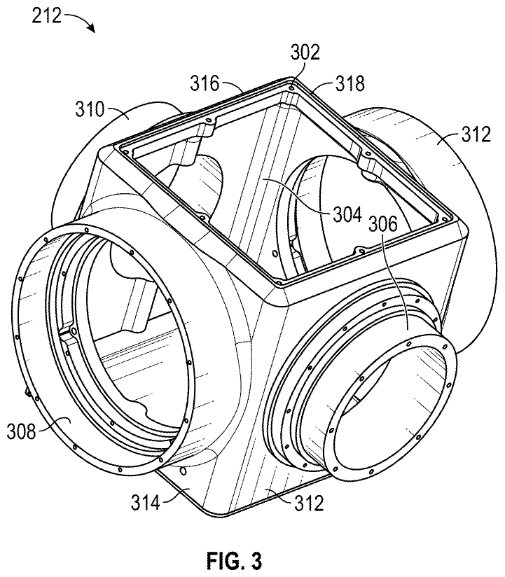

FIG. 3 illustrates details of the third link member 212 according to an embodiment of the present disclosure. The third link member 212 includes a housing 302 that defines a chamber 304. In an embodiment, the housing 302 is rectangular in shape. However, the housing 302 can be other shapes such as spherical, polygonal or the like. In an embodiment, the housing 302 has four surfaces. A first surface 312 may be orthogonal to a second surface 314. The second surface 314 may be orthogonal to a third surface 316, and the third surface 316 may be orthogonal to a fourth surface 318. In an embodiment, the first surface 312 is parallel to the third surface 316 and the second surface 314 is parallel to the fourth surface 318. In another embodiment, the first surface may be opposite to the third surface 316 and the second surface 314 may be opposite to the fourth surface 318. Each of the first surface 312, the second surface 314, the third surface 316, and the fourth surface 318 may include an interface feature to couple to a first motor assembly, a second motor assembly, a third motor assembly and a fourth motor assembly, respectively. In an embodiment, the first surface 312 may include a first interface feature 306 to couple with the first motor assembly. The second surface 314 may include a second interface feature 308 to couple with the second motor assembly. The third surface 316 may include a third interface feature 310 to couple with the third motor assembly and the fourth surface 318 may include a fourth interface feature 312 to couple with the fourth motor assembly. In an embodiment, the first connection feature 306 may be coupled with another link member (e.g., the first link member 204 of FIG. 2A) and the third connection feature 310 may be coupled to yet another link member (e.g., the second link member 208 of FIG. 2A). In an embodiment, the third link member 212 may be made from any suitable metal or alloy known in the industry.

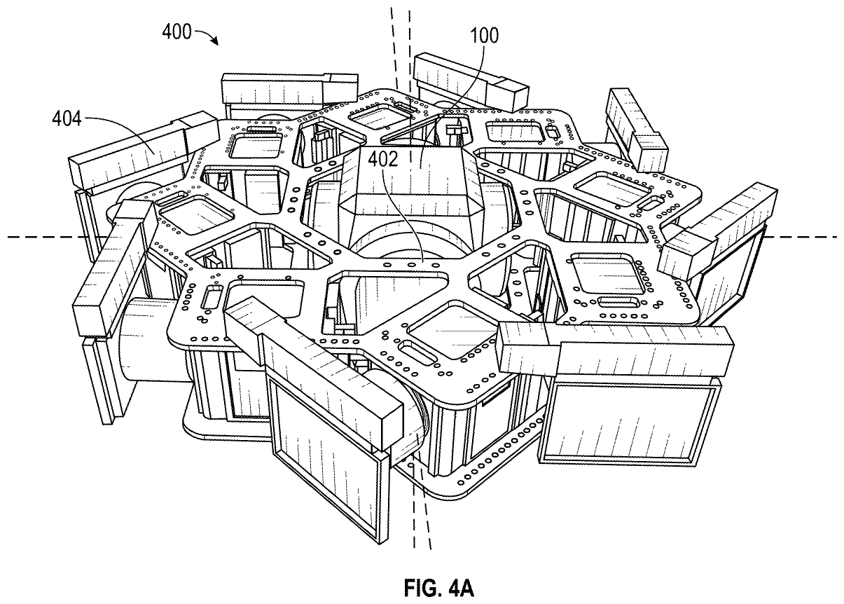

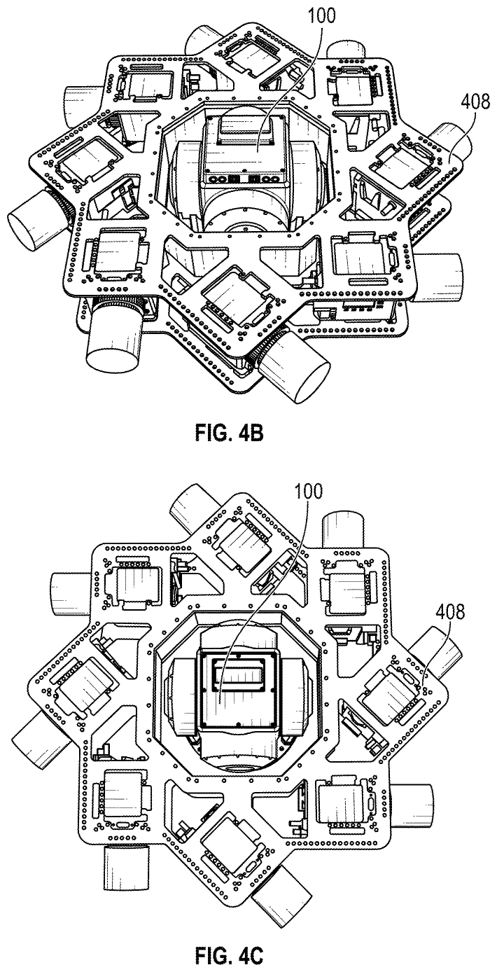

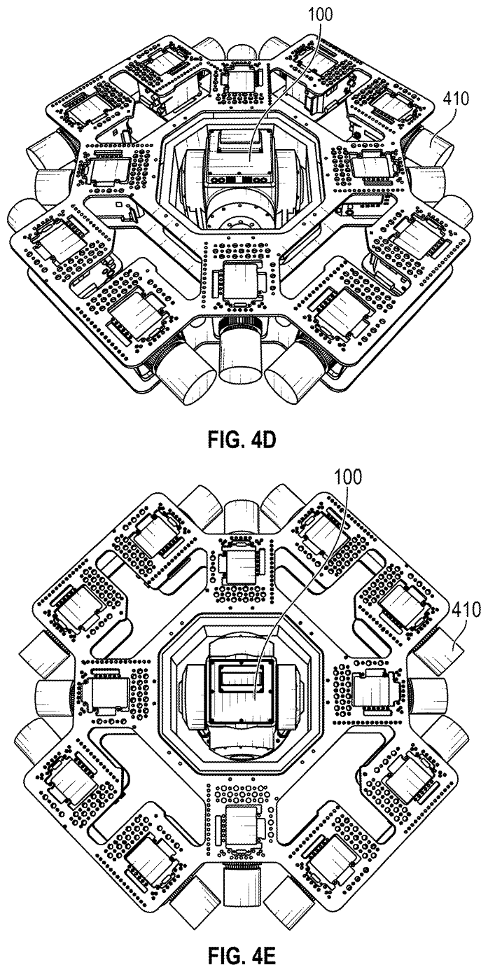

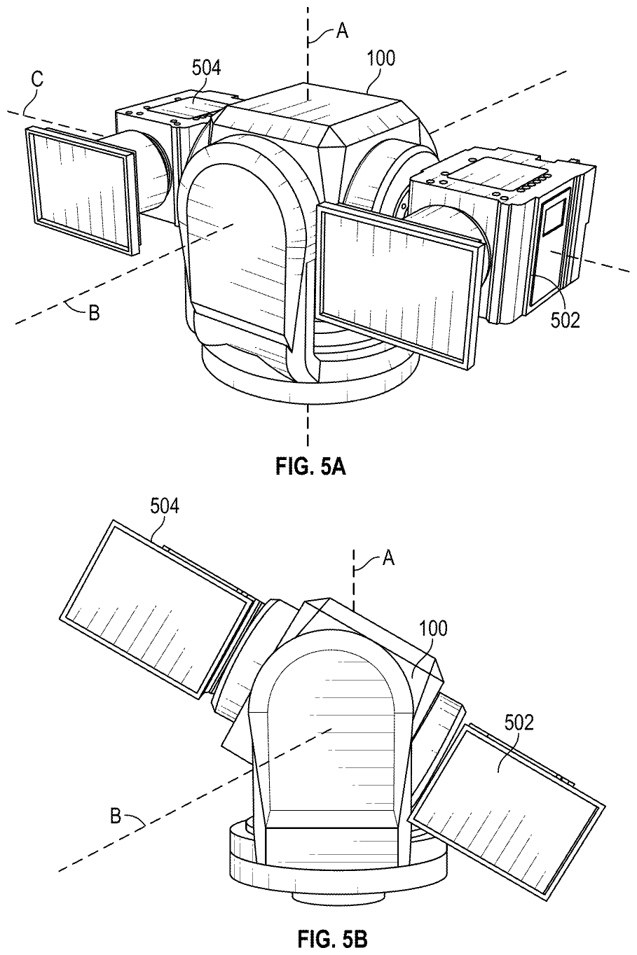

FIGS. 4A-4E illustrate various configurations of the camera mounting/universal stabilizing system 400 according to an embodiment of the present disclosure. As illustrated in FIG. 4A, the camera mounting system 400 includes the universal stabilization system 100 described above, a payload mount frame 402 and one or more payloads 404. In an embodiment, the payload mounting frame 402 is connected to the universal stabilization system 100 and encircles the universal stabilization system 100. In an embodiment, the payload mounting frame 402 may be connected to the fourth rotor of the fourth motor and to the fifth rotor of the fifth motor described above. This places the universal stabilization system 100 at the center of gravity of the camera mounting system 400 and payload 404 is connected to the periphery of the universal stabilization system 100. This is different from conventional stabilization systems in which the payload is usually placed at the center of gravity. The design of the universal stabilization system 100 allows for multiple payloads to be connected to the universal stabilization system 100 and since the universal stabilization system 100 is placed at the center of gravity of the camera mounting system 400, it provides for a more stable and robust operation of multiple payloads. In an embodiment, the universal stabilization system 100 may support up to 20 concurrent payloads. This type of versatility is not possible with conventional gimbal-based stabilization systems. In some embodiments, the payload mounting frame 402 may be designed to accommodate a first number of payloads, but in practice a second number of payloads are mounted to the payload mounting frame 402, where the second number is less than the first number. In such an instance, one or more counterweights may be added to the payload mounting frame 402 at appropriate locations to balance the camera mounting system 400. In order to achieve optimum balance for any number of payloads, mounting frame 402 can be adjusted along the axis B and axis C in order to fine tune center balance about universal stabilization system 100. In some embodiments, this adjustment can either be automated along linear worm gears or manually configured.

FIG. 4B and FIG. 4C illustrate an 8-camera pin-wheel configuration of the universal stabilizing system according to an embodiment of the present disclosure. This configuration may include a universal stabilizing system 100 with 8 payloads 408 attached to it via a mounting frame. The payloads 408 (or 404 above) may be arranged about a 45 degree rotation offset from one another to achieve a 360-degree field of view coverage. FIGS. 4D and 4E illustrate a 12-camera toe-in configuration according to an embodiment of the present disclosure. In this embodiment, the payloads 410 may be arranged in a toed-in configuration about a 45-degree rotational offset from one another to achieve a 360-degree field of view coverage.

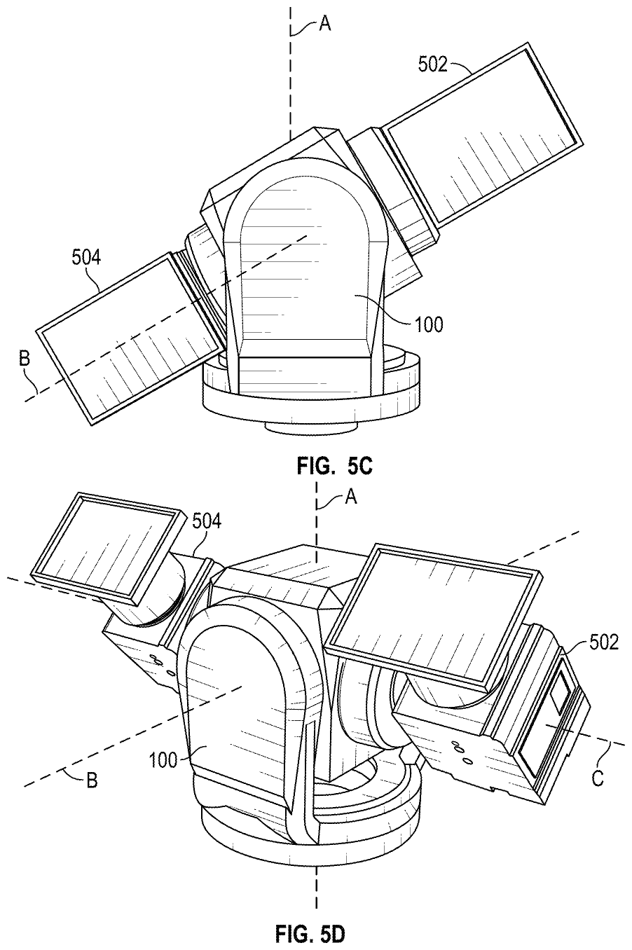

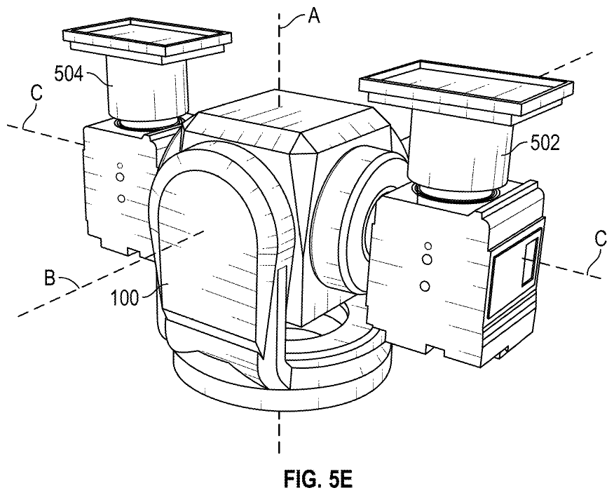

FIGS. 5A-5E illustrate the operation of the universal stabilization system 100 according to an embodiment of the present disclosure. The first motor assembly 102 of the universal stabilization system 100 may provide a pan motion for the one or more payloads, the second motor assembly 106 and the third motor assembly 108 may provide a roll motion for the one or more payloads and the fourth motor assembly 112 and the fifth motor assembly 114 may provide a tilt motion for the one or more payloads. In an embodiment, the pan and the tilt motion may be infinite such that they cover over 360 degrees of motion while the roll motion may be less than 360 degrees.

FIG. 5A illustrates the universal stabilization system 100 coupled to a first payload 502 and a second payload 504. It is to be noted that only two payloads are shown here for ease of explanation. As noted above, the universal stabilization system 100 is capable of supporting between 1 to 20 payloads concurrently. Also, the universal stabilization system 100 can support a single payload. In this instance, the second payload may be replaced by a dummy counter-weight to maintain proper balance of the universal stabilization system 100. FIG. 5B illustrates movement of the universal stabilization system 100 along the axis B that results in a roll motion. FIG. 5C illustrates movement the universal stabilization system 100 along the axis B that is in the other direction than what is shown in FIG. 5B. FIGS. 5D and 5E illustrate the motion of the universal stabilization system around the axis C, which results in a tilt motion. The universal stabilization system 100 can rotate the tilt motors infinitely or a full 360 degrees in both clockwise and anticlockwise directions around the axis C.

In some embodiments, the universal stabilization system 100 may include less than five motor assemblies. For example, in a particular embodiment, the universal stabilization system 100 may include only three motor assemblies. In this embodiment, housing for the third motor assembly 108 and the fifth motor assembly 114 may be empty or may include other components such as electrical components. The rest of the form factor of the universal stabilization system 100 may remain the same.

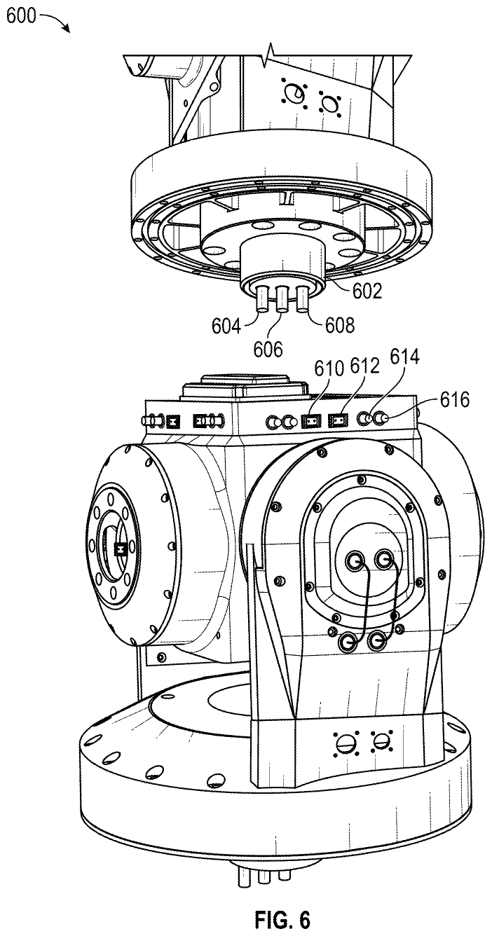

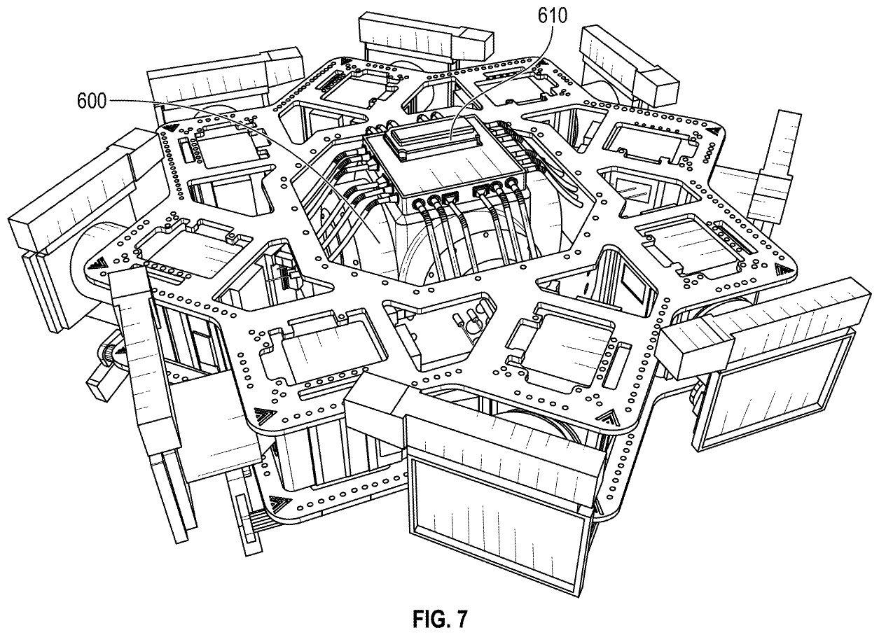

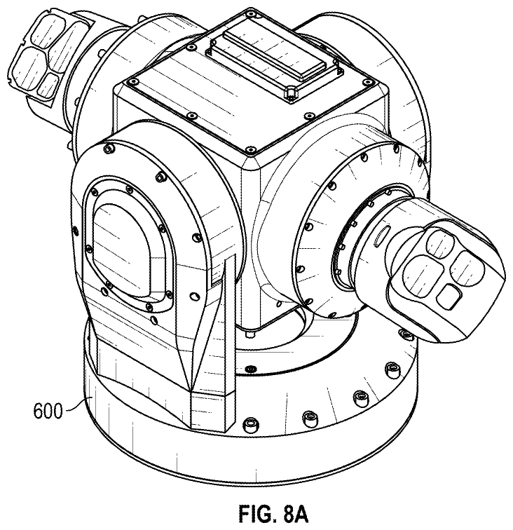

FIG. 6 illustrates a universal stabilization system 600 that includes a power management system according to another embodiment of the present disclosure. The universal stabilization system 600 may include a base 602 that can accommodate multiple power and communication cables 604, 606, and 608. These are the common power and communication input to the universal stabilization system 600. The universal stabilization system 600 may also include a power distribution unit 610 that receives the power and communication inputs via the cables 604-608 and distribute power and communication signals to each of the payload connected to the universal stabilization system 600. In an embodiment where the universal stabilization system 600 has one or more camera payloads attached to it, the power and communication inputs may include camera lens control, power, and motor control inputs to drive the various motors of the universal stabilization system 600. FIG. 7 illustrates an embodiment that shows how the power and communication distribution unit 610 is connected to each of the payloads that are attached to the universal stabilization system 600. In various embodiments, the power management system configured to control the power state of one or more of the motor assemblies. The power management system may be configured to selectively enable or disable power to individual motor assemblies, groups of motor assemblies, or all motor assemblies. In an embodiment, the power management system may include a power run/stop control for each motor assembly. The power run/stop control may be configured to switch the corresponding motor assembly between a powered state (run) and an unpowered state (stop). In the powered state, the motor assembly may be configured to actively stabilize the payload by adjusting its rotational position in response to control signals. In the unpowered state, the motor assembly may be configured to allow free rotation or may be configured to maintain a fixed position through mechanical braking or other means. In an embodiment, the power management system may include a master power run/stop control configured to simultaneously control the power state of all motor assemblies. The master power run/stop control may be used to quickly enable or disable the entire universal stabilization system. In an embodiment, the power management system may include individual power run/stop controls for each axis of motion. For example, a first power run/stop control may be configured to control the power state of the first motor assembly (pan axis), a second power run/stop control may be configured to control the power state of the second motor assembly and the third motor assembly (roll axis), and a third power run/stop control may be configured to control the power state of the fourth motor assembly and the fifth motor assembly (tilt axis).

The power run/stop controls may be implemented using various mechanisms, including but not limited to physical switches; electronic switches (e.g., transistors, relays); software controls; remote controls; and any combination thereof. In some embodiments, the power run/stop controls may be accessible via a user interface, such as a control panel, a remote control device, a mobile application, or a computer interface. In an embodiment, the power management system may be configured to automatically control the power state of the motor assemblies based on various conditions. For example, the power management system may be configured to automatically disable power to the motor assemblies when the universal stabilization system is not in use, when a low battery condition is detected, when an overtemperature condition is detected, or when a fault condition is detected. In an embodiment, the power management system may be configured to implement a soft start and/or soft stop function for the motor assemblies. The soft start function may be configured to gradually increase power to the motor assemblies when transitioning from the unpowered state to the powered state, reducing mechanical stress and preventing sudden movements. The soft stop function may be configured to gradually decrease power to the motor assemblies when transitioning from the powered state to the unpowered state, allowing the motor assemblies to smoothly decelerate to a stop. In an embodiment, the power management system may be configured to implement a sleep mode or low-power mode for the motor assemblies. In the sleep mode, the motor assemblies may be configured to consume minimal power while maintaining the ability to quickly resume normal operation when needed.

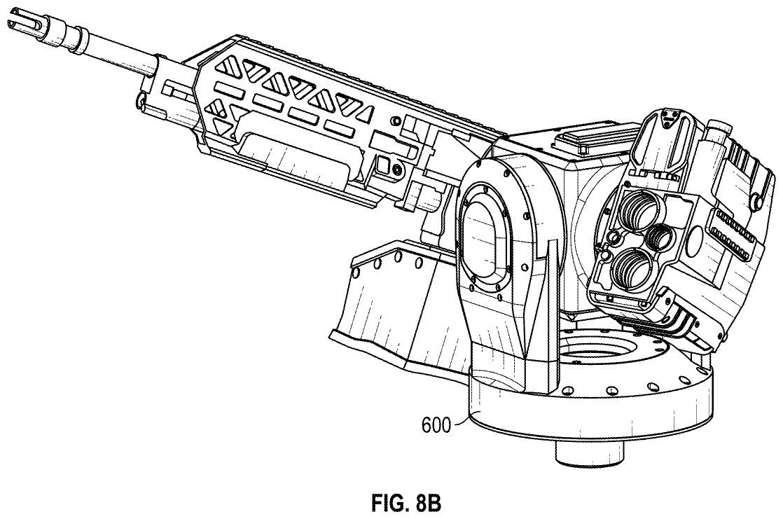

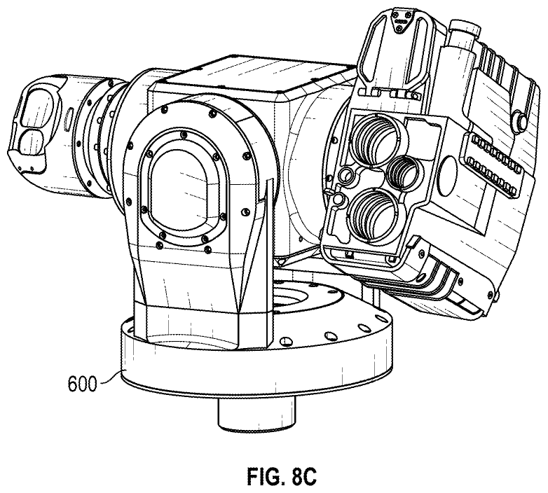

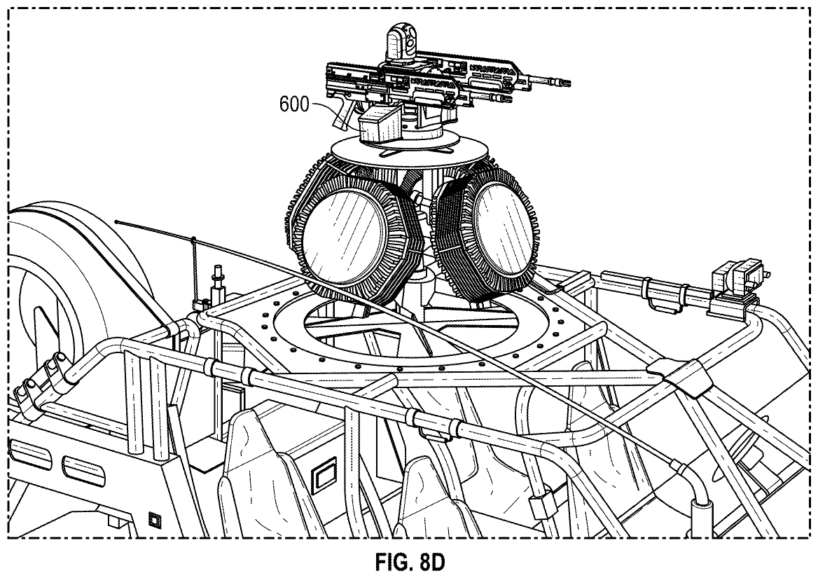

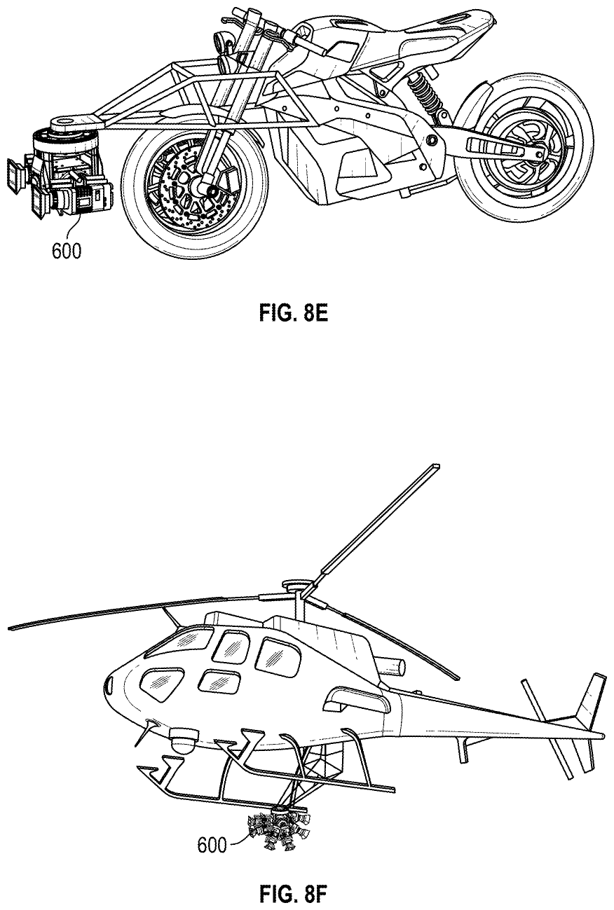

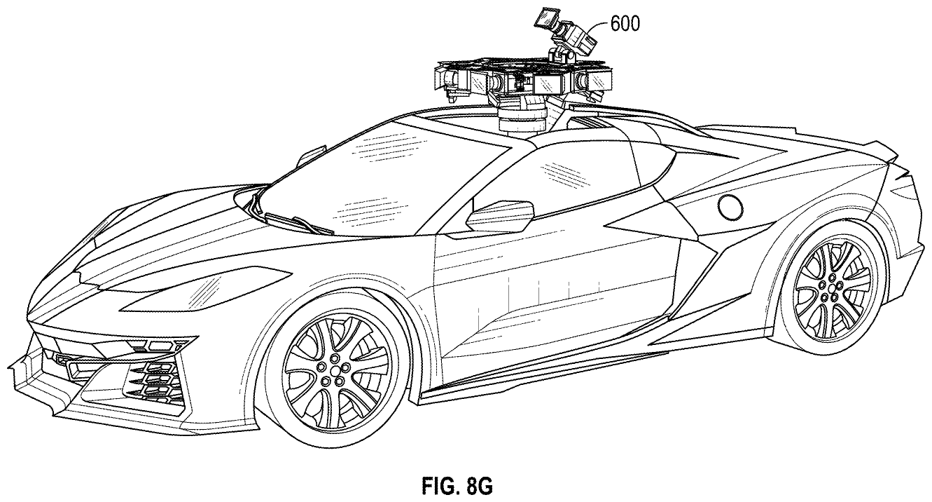

FIGS. 8A-8G illustrate various environments in which the various embodiments of the universal stabilization system may be used. While the present disclosure describes cameras as example payloads, the universal stabilization system may be configured to support a wide variety of payload types. The term “payload” as used herein may refer to any device, instrument, sensor, equipment, or apparatus that may benefit from stabilization during operation. In various embodiments, the payloads may include one or more imaging devices. Imaging devices may include but are not limited to digital cameras; film cameras; video cameras; cinema cameras; broadcast cameras; action cameras; 360-degree cameras; stereoscopic cameras; light field cameras; high-speed cameras; time-lapse cameras; infrared cameras; ultraviolet cameras; X-ray imaging devices; and any combination thereof. In various embodiments, the payloads may include one or more thermal imaging devices. Thermal imaging devices, also known as infrared cameras or thermographic cameras, may be configured to detect infrared radiation and produce images based on temperature differences. Thermal imaging devices may be used for various applications, including but not limited to surveillance and security; search and rescue operations; building inspection and energy auditing; industrial process monitoring; firefighting; wildlife observation; medical imaging; and military and defense applications.

In other embodiments, the payloads may include one or more sensors. Sensors may include but are not limited to: LIDAR (Light Detection and Ranging) sensors; RADAR (Radio Detection and Ranging) sensors; sonar sensors; ultrasonic sensors; multispectral sensors; hyperspectral sensors; electromagnetic sensors; radiation sensors; chemical sensors; biological sensors; environmental sensors (e.g., temperature, humidity, pressure, air quality); motion sensors; proximity sensors; and any combination thereof. In various embodiments, the payloads may include one or more military or defense sensors and equipment. Military and defense payloads may include but are not limited to electro-optical/infrared (EO/IR) sensors; forward-looking infrared (FLIR) systems; laser designators; laser rangefinders; target acquisition systems; reconnaissance sensors; surveillance equipment; intelligence gathering devices; electronic warfare equipment; communication antennas; radar systems; and any combination thereof. In various embodiments, the payloads may include one or more scientific instruments. Scientific instruments may include but are not limited to spectrometers; telescopes; microscopes; atmospheric sensors; oceanographic sensors; geological sensors; astronomical instruments; meteorological instruments; and any combination thereof. In various embodiments, the payloads may include one or more communication devices. Communication devices may include but are not limited to directional antennas; satellite communication terminals; radio frequency (RF) transmitters and receivers; microwave transmitters and receivers; laser communication terminals; and any combination thereof.

In other embodiments, the payloads may include one or more lighting devices. Lighting devices may include but are not limited to spotlights; searchlights; LED panels; strobe lights; infrared illuminators; ultraviolet lights; and any combination thereof. In various embodiments, the payloads may include one or more projection devices. Projection devices may include but are not limited to video projectors; laser projectors; holographic projectors; and any combination thereof. In various embodiments, the payloads may include one or more weapons or weapon systems. Weapons or weapon systems may include but are not limited to firearms; non-lethal weapons; directed energy weapons; and any combination thereof. In various embodiments, the payloads may include one or more robotic end effectors. Robotic end effectors may include but are not limited to grippers; manipulators; tools; and any combination thereof.

The universal stabilization system may be configured to support payloads of varying sizes, weights, and form factors. In some embodiments, the payload mounting frame may be customized or adapted to accommodate specific payload types. In some embodiments, adapter plates, brackets, or other mounting hardware may be used to couple various payload types to the universal stabilization system. The universal stabilization system may be configured to support multiple different types of payloads simultaneously. For example, the universal stabilization system may support a combination of a visible light camera and a thermal imaging device, allowing for simultaneous capture of visible and infrared imagery. In another example, the universal stabilization system may support a combination of a camera and a LIDAR sensor, allowing for simultaneous capture of imagery and three-dimensional point cloud data.

The universal stabilization system may be configured for mounting to various platforms, structures, and vehicles as illustrated in FIGS. 8A-8G. The system mount of the first motor assembly may be configured to couple to a complementary connector on the platform, structure, or vehicle. In some embodiments, adapter plates, brackets, or other mounting hardware may be used to couple the universal stabilization system to various platforms. In some embodiments, the universal stabilization system may be mounted to land-based vehicles. Land-based vehicles may include, but are not limited to automobiles (e.g., cars, trucks, vans, SUVs); motorcycles; all-terrain vehicles (ATVs); utility task vehicles (UTVs); recreational vehicles (RVs); buses; trains; tanks; armored personnel carriers; military ground vehicles; construction vehicles; agricultural vehicles; mining vehicles; and any other vehicle configured to travel on land. In an embodiment, the universal stabilization system may be mounted to the roof of a vehicle. The roof mount may provide an elevated vantage point for the payloads while minimizing obstruction from the vehicle body. In an embodiment, the universal stabilization system may be mounted to the hood, trunk, or other exterior surface of a vehicle. In an embodiment, the universal stabilization system may be mounted inside a vehicle, with the payloads extending through an opening in the vehicle body (e.g., a sunroof, a window, or a dedicated port). In an embodiment, the universal stabilization system may be mounted to a vehicle using a quick-release mechanism, allowing for rapid installation and removal of the system. In an embodiment, the universal stabilization system may be permanently installed on a vehicle.

In various embodiments, the universal stabilization system may be mounted to aerial vehicles. Aerial vehicles may include but are not limited to helicopters; airplanes; unmanned aerial vehicles (UAVs) or drones; blimps; airships; balloons; paragliders; hang gliders; and any other vehicle configured to travel through the air. In an embodiment, the universal stabilization system may be mounted to the underside of a helicopter. The underslung mount may provide an unobstructed field of view for the payloads while minimizing interference from the helicopter body and rotor wash. In an embodiment, the universal stabilization system may be mounted to the nose, tail, or side of a helicopter. In an embodiment, the universal stabilization system may be mounted to the underside of an airplane. In an embodiment, the universal stabilization system may be mounted in a pod or nacelle attached to the wing or fuselage of an airplane. In an embodiment, the universal stabilization system may be mounted in a turret or dome on the airplane. In an embodiment, the universal stabilization system may be mounted to a UAV or drone. The universal stabilization system may be scaled appropriately for the size and payload capacity of the UAV. In some embodiments, a miniaturized version of the universal stabilization system may be used for smaller UAVs.

In various embodiments, the universal stabilization system may be mounted to marine vehicles. Marine vehicles may include but are not limited to boats; ships; yachts; submarines; personal watercraft; kayaks; canoes; and any other vehicle configured to travel on or under water. In an embodiment, the universal stabilization system may be mounted to the deck, mast, or superstructure of a boat or ship. In an embodiment, the universal stabilization system may be mounted in a weatherproof enclosure to protect against water, salt, and other environmental factors.

In various embodiments, the universal stabilization system may be mounted to stationary platforms. Stationary platforms may include but are not limited to tripods; monopods; pedestals; towers; buildings; bridges; cranes; jibs; dollies; sliders; cable cam systems; motion control rigs; and any other stationary or semi-stationary structure. In an embodiment, the universal stabilization system may be mounted to a tripod for use in film production, photography, surveillance, or other applications. In an embodiment, the universal stabilization system may be mounted to a crane or jib for elevated shots in film production. In an embodiment, the universal stabilization system may be mounted to a building or other structure for permanent or semi-permanent surveillance, monitoring, or observation applications.

In various embodiments, the universal stabilization system may be configured for handheld use. In an embodiment, the universal stabilization system may include one or more handles or grips coupled to the system mount, allowing an operator to hold and manipulate the system by hand. In various embodiments, the universal stabilization system may be configured for body-mounted use. In an embodiment, the universal stabilization system may be mounted to a vest, harness, or other body-worn apparatus. This configuration may allow an operator to support the weight of the system using their body while maintaining freedom of movement.

The universal stabilization system may be configured for operation in various environmental conditions. In some embodiments, the universal stabilization system may include weatherproofing, sealing, or other protective features to enable operation in rain, snow, dust, sand, or other adverse conditions. In some embodiments, the universal stabilization system may be configured for operation in extreme temperatures, including both high-temperature environments (e.g., deserts, industrial settings) and low-temperature environments (e.g., arctic regions, high altitudes). In some embodiments, the universal stabilization system may be configured for operation in high-vibration environments, such as on vehicles with rough terrain or high-speed operation. The stabilization provided by the motor assemblies may compensate for vibrations transmitted from the mounting platform. In some embodiments, the universal stabilization system may be configured for operation in high-altitude or low-pressure environments. In some embodiments, the universal stabilization system may be configured for operation in underwater environments, with appropriate sealing and pressure compensation. The universal stabilization system may be designed with scalability in mind, allowing the system to accommodate payloads of varying sizes, weights, and configurations. The scalability of the system may be achieved through various design features and configurations.

In various embodiments, the motor assemblies of the universal stabilization system may be selected or configured based on the expected payload weight. Motors with higher torque ratings may be used for heavier payloads, while motors with lower torque ratings may be used for lighter payloads. In some embodiments, the universal stabilization system may be available in multiple size variants, each optimized for a different payload weight range. In an embodiment, the universal stabilization system may be configured to support payloads ranging from less than 1 kilogram to more than 100 kilograms. In various embodiments, the payload mounting frame may be configured to accommodate payloads of varying sizes. The payload mounting frame may include adjustable mounting points, rails, or brackets that can be repositioned to fit different payload sizes. In some embodiments, the payload mounting frame may be modular, allowing sections to be added or removed to accommodate larger or smaller payloads. In an embodiment, the third link member may be available in multiple sizes, with larger versions providing greater clearance for larger payloads and smaller versions providing a more compact form factor for smaller payloads.

As described above, the universal stabilization system may be configured to support multiple payloads simultaneously. The number of payloads that can be supported may depend on the size and weight of the individual payloads, the capacity of the motor assemblies, and the configuration of the payload mounting frame. In an embodiment, the universal stabilization system may be configured to support between 1 and 20 payloads concurrently. In other embodiments, the universal stabilization system may be configured to support more than 20 payloads concurrently. In an embodiment, the payload mounting frame may include multiple mounting positions arranged symmetrically around the universal stabilization system. The symmetric arrangement may help maintain balance when multiple payloads are mounted.

In various embodiments, the universal stabilization system may have a modular design that allows components to be added, removed, or replaced to accommodate different applications. For example, the motor assemblies may be modular, allowing motors of different sizes or specifications to be swapped in or out based on the requirements of the application. In an embodiment, the link members may be modular, allowing link members of different lengths or configurations to be used. Longer link members may provide greater range of motion or clearance for larger payloads, while shorter link members may provide a more compact form factor. In an embodiment, the payload mounting frame may be modular, allowing different frame configurations to be used for different applications. For example, a first frame configuration may be optimized for mounting multiple cameras in a circular arrangement, while a second frame configuration may be optimized for mounting a single large sensor.

In various embodiments, the control system of the universal stabilization system may be configured to adapt to different payload configurations. The control system may include algorithms that automatically detect the payload configuration and adjust the control parameters accordingly. In an embodiment, the control system may include a calibration routine that measures the weight and balance of the mounted payloads and adjusts the motor control parameters to optimize stabilization performance. In an embodiment, the control system may include preset configurations for common payload types, allowing operators to quickly configure the system for specific applications.

In various embodiments, the universal stabilization system may be configured for military and defense applications. The universal stabilization system may provide stabilized mounting for a wide variety of military payloads, including sensors, weapons, communication equipment, and other defense-related devices. The stabilization provided by the motor assemblies may enable accurate targeting, surveillance, reconnaissance, and other military operations from moving platforms such as ground vehicles, aircraft, watercraft, and unmanned systems. The universal stabilization system may be particularly advantageous for military applications due to its ability to support multiple payloads simultaneously. For example, a single universal stabilization system may support a combination of electro-optical sensors, infrared sensors, laser designators, and other equipment, providing a multi-function capability in a single stabilized platform.

In various embodiments, the universal stabilization system may support one or more military sensor payloads. Military sensor payloads may include but are not limited to Electro-Optical/Infrared (EO/IR) Sensors. The universal stabilization system may support EO/IR sensor systems that combine visible light cameras with infrared imaging capabilities. EO/IR sensors may be used for surveillance, reconnaissance, target acquisition, and tracking applications. The stabilization provided by the universal stabilization system may enable clear imagery even when the mounting platform is in motion or subject to vibration. The universal stabilization system may support Forward-Looking Infrared (FLIR) Systems. The universal stabilization system may support FLIR systems configured to detect infrared radiation emitted by objects, people, vehicles, and other heat sources. FLIR systems may be used for night vision, search and rescue, perimeter security, and target detection applications. In other embodiments, the universal stabilization system may support thermal imaging systems configured to produce images based on temperature differences. Thermal imaging systems may be used to detect concealed personnel, identify recently operated vehicles or equipment, locate underground structures, and perform other thermal surveillance functions. In some instances, the universal stabilization system may support multispectral and hyperspectral imaging sensors configured to capture imagery across multiple wavelength bands. These sensors may be used for camouflage detection, material identification, environmental monitoring, and intelligence gathering applications. As noted above, the universal stabilization system may support LIDAR (Light Detection and Ranging) systems configured to generate three-dimensional maps of terrain, structures, and objects. Military LIDAR systems may be used for terrain mapping, obstacle detection, target mensuration, and autonomous navigation applications. The universal stabilization system may also support compact RADAR (Radio Detection and Ranging) systems configured to detect and track aircraft, vehicles, personnel, and other objects. RADAR systems may include synthetic aperture radar (SAR), ground-penetrating radar (GPR), and other specialized radar types.

In some embodiments, the universal stabilization system may support SIGINT sensors configured to intercept and analyze electronic signals, including communications signals (COMINT) and electronic emissions (ELINT). SIGINT sensors may include direction-finding antennas, spectrum analyzers, and signal processing equipment. The universal stabilization system may also support electronic warfare equipment configured to detect, deny, deceive, disrupt, or destroy enemy electronic systems. EW equipment may include radar jammers, communications jammers, infrared countermeasures, and other electronic attack and protection systems. In some embodiments, the universal stabilization system may support CBRN sensors configured to detect chemical agents, biological agents, radiological materials, and nuclear materials. CBRN sensors may be used for early warning, contamination mapping, and hazard assessment applications. The universal stabilization system may also support acoustic sensors configured to detect and locate sound sources, such as gunfire, explosions, vehicles, and personnel. Acoustic sensors may include gunshot detection systems, sonar systems, and other acoustic surveillance equipment.

In various embodiments, the universal stabilization system may support one or more laser systems. For example, the universal stabilization system may support laser designators configured to illuminate targets for laser-guided munitions. The stabilization provided by the universal stabilization system may enable precise designation of targets from moving platforms, improving the accuracy of guided weapons. The universal stabilization system may also support laser rangefinders configured to measure the distance to targets. Laser rangefinders may be used for fire control, surveying, and navigation applications. In some instances, the universal stabilization system may support laser illuminators configured to provide covert illumination for night vision devices. Laser illuminators may operate in the near-infrared spectrum, invisible to the naked eye but detectable by compatible imaging systems. In other embodiments, the universal stabilization system may support laser dazzlers configured to temporarily impair the vision of personnel or the sensors of vehicles and aircraft. Laser dazzlers may be used as non-lethal weapons for crowd control, checkpoint security, and anti-aircraft defense applications. In yet other embodiments, the universal stabilization system may support high-energy laser weapons configured to damage or destroy targets through the application of directed energy. HEL weapons may be used for counter-unmanned aerial system (C-UAS) applications, missile defense, and other directed energy weapon applications. The stabilization provided by the universal stabilization system may enable precise beam pointing and tracking of moving targets.

In various embodiments, the universal stabilization system may support one or more weapon system payloads. For instance, the universal stabilization system may be integrated with or support remote weapon stations configured to mount and operate firearms from a protected position. Remote weapon stations may include machine guns, automatic grenade launchers, anti-tank guided missiles, and other weapons. The universal stabilization system may also support machine guns of various calibers, including light machine guns (e.g., 5.56 mm, 7.62 mm), medium machine guns (e.g., 7.62 mm), and heavy machine guns (e.g., .50 caliber, 12.7 mm). The stabilization provided by the universal stabilization system may improve accuracy during sustained fire from moving platforms. In some embodiments, the universal stabilization system may support automatic grenade launchers configured to fire explosive grenades at high rates of fire. Automatic grenade launchers may be used for area suppression, anti-personnel, and light anti-armor applications. In other embodiments, the universal stabilization system may support anti-tank guided missile launchers configured to engage armored vehicles and fortified positions. The stabilization provided by the universal stabilization system may enable accurate missile guidance during launch and flight. In a particular embodiment, the universal stabilization system may support surface-to-air missile launchers configured to engage aircraft, helicopters, and unmanned aerial vehicles. The stabilization provided by the universal stabilization system may enable accurate tracking and engagement of aerial targets.

In some embodiments, the universal stabilization system may support rocket launchers configured to fire unguided or guided rockets. Rocket launchers may be used for area suppression, anti-personnel, anti-armor, and anti-structure applications. The universal stabilization system may also support cannons and autocannons of various calibers (e.g., 20 mm, 25 mm, 30 mm, 40 mm). The stabilization provided by the universal stabilization system may improve accuracy during rapid fire from moving platforms. The universal stabilization system may also support non-lethal weapons configured to incapacitate personnel without causing permanent injury or death. Non-lethal weapons may include acoustic devices (e.g., long-range acoustic devices, or LRADs), directed energy weapons (e.g., active denial systems), kinetic weapons (e.g., rubber bullets, bean bag rounds), and chemical agents (e.g., tear gas, pepper spray). In some instances, the universal stabilization system may support C-UAS weapons configured to detect, track, and neutralize unmanned aerial vehicles (drones). C-UAS weapons may include radio frequency jammers, GPS spoofers, directed energy weapons, kinetic interceptors, and net-based capture systems.

In various embodiments, the universal stabilization system may support one or more communication and data link payloads. For example, the universal stabilization system may support directional antennas configured to transmit and receive radio frequency signals in a specific direction. The stabilization provided by the universal stabilization system may enable the antenna to maintain alignment with a communication satellite, relay station, or other communication node while the mounting platform is in motion. The universal stabilization system may support SATCOM terminals configured to communicate with military communication satellites. SATCOM terminals may provide beyond-line-of-sight communication capabilities for voice, data, and video transmission. The universal stabilization system may support tactical data link equipment configured to share information between military platforms in real-time. Tactical data links may include Link 16, Link 22, and other standardized military data link systems. The universal stabilization system may support radio relay equipment configured to extend the range of tactical radio communications. Radio relay equipment may be mounted on elevated platforms (e.g., aircraft, towers) to provide line-of-sight communication over extended distances. The universal stabilization system may support ELINT antennas configured to intercept and analyze radar and other electronic emissions. ELINT antennas may be used for threat detection, electronic order of battle development, and electronic warfare support.

In various embodiments, the universal stabilization system may be integrated with unmanned systems, including unmanned ground vehicles (UGVs), unmanned aerial vehicles (UAVs), unmanned surface vehicles (USVs), and unmanned underwater vehicles (UUVs). The universal stabilization system may be mounted on UGVs configured for reconnaissance, surveillance, explosive ordnance disposal (EOD), logistics, and combat applications. The stabilization provided by the universal stabilization system may enable clear sensor imagery and accurate weapon fire while the UGV traverses rough terrain. The universal stabilization system may be mounted on UAVs configured for intelligence, surveillance, and reconnaissance (ISR), strike, electronic warfare, and other applications. The universal stabilization system may be scaled appropriately for the size and payload capacity of the UAV, from small tactical UAVs to large high-altitude long-endurance (HALE) platforms. The universal stabilization system may be mounted on USVs configured for maritime surveillance, mine countermeasures, anti-submarine warfare, and other naval applications. The stabilization provided by the universal stabilization system may compensate for wave-induced motion of the USV. The universal stabilization system may be mounted on UUVs configured for underwater reconnaissance, mine detection, and other subsurface applications. The universal stabilization system may be configured with appropriate sealing and pressure compensation for underwater operation.

In various embodiments, the universal stabilization system may be integrated with military vehicles, including armored vehicles, tactical vehicles, aircraft, and watercraft. The universal stabilization system may be mounted on armored vehicles such as main battle tanks, infantry fighting vehicles, armored personnel carriers, and mine-resistant ambush protected (MRAP) vehicles. The stabilization provided by the universal stabilization system may enable accurate fire-on-the-move capability and stabilized sensor imagery while traversing rough terrain. The universal stabilization system may be mounted on tactical vehicles such as light tactical vehicles, medium tactical vehicles, and heavy tactical vehicles. The universal stabilization system may support reconnaissance, surveillance, communication, and weapon system payloads on tactical vehicles. The universal stabilization system may be mounted on helicopters configured for attack, reconnaissance, transport, and search and rescue missions. The stabilization provided by the universal stabilization system may compensate for vibration from the rotor system and enable accurate sensor imagery and weapon fire. The universal stabilization system may be mounted on fixed-wing aircraft configured for ISR, strike, electronic warfare, and other missions. The universal stabilization system may be mounted in pods, turrets, or internal bays on the aircraft. The universal stabilization system may be mounted on naval vessels such as aircraft carriers, destroyers, frigates, corvettes, patrol boats, and amphibious assault ships. The stabilization provided by the universal stabilization system may compensate for ship motion due to waves and enable accurate sensor imagery and weapon fire.

In various embodiments, the universal stabilization system may be ruggedized for military applications. The universal stabilization system may be configured to withstand shock and vibration levels encountered in military environments, including vehicle motion, weapon recoil, and nearby explosions. The universal stabilization system may include environmental sealing to protect against water, dust, sand, and other contaminants. The environmental sealing may conform to military standards such as MIL-STD-810 for environmental engineering considerations. The universal stabilization system may be configured for electromagnetic compatibility, including resistance to electromagnetic interference (EMI) and limited electromagnetic emissions. EMC compliance may conform to military standards such as MIL-STD-461 for electromagnetic interference characteristics. The universal stabilization system may be configured for operation across a wide temperature range, including extreme cold (e.g., −40° C. or below) and extreme heat (e.g., +50° C. or above). The universal stabilization system may include corrosion-resistant materials and coatings to enable operation in maritime and other corrosive environments. In some embodiments, the universal stabilization system may include ballistic protection to protect critical components from small arms fire and fragmentation.

In various embodiments, the universal stabilization system may be integrated with fire control systems configured to aim and fire weapons. The universal stabilization system may be configured to automatically track targets based on input from sensors, enabling the weapon to remain aimed at a moving target. The fire control system may compute ballistic solutions based on target range, target motion, wind, temperature, and other factors, and command the universal stabilization system to aim the weapon accordingly. For engaging moving targets, the fire control system may compute the required lead angle and command the universal stabilization system to aim ahead of the target. The universal stabilization system may support multiple stabilization modes, including stabilized observation (sensor stabilized, weapon follows), stabilized weapon (weapon stabilized, sensor follows), and independent operation (sensor and weapon stabilized independently).

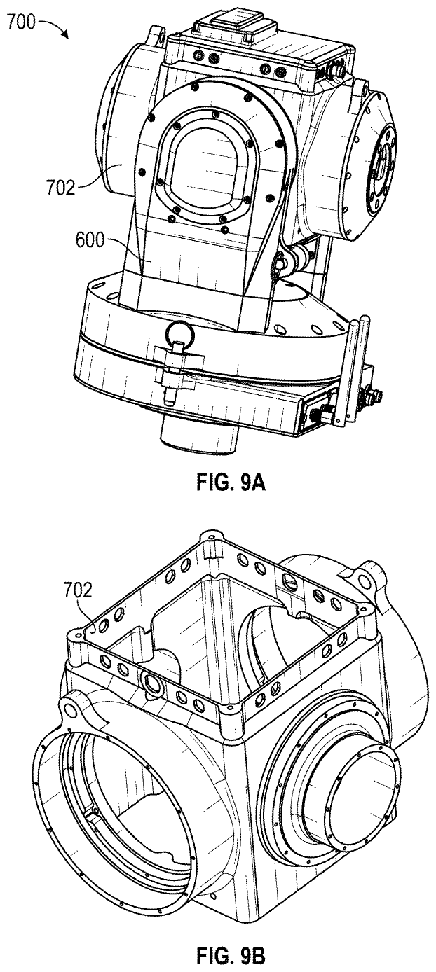

FIG. 9A illustrates a universal stabilization system assembly 700 that includes the universal stabilization system 600 with one or more slip rings 702 according to yet another embodiment of the present disclosure. In various embodiments, the universal stabilization system may include one or more slip rings 702 coupled to one or more of the motor assemblies. A slip ring, also known as a rotary electrical interface, rotating electrical connector, collector, swivel, or electrical rotary joint, is an electromechanical device that allows the transmission of power and electrical signals from a stationary structure to a rotating structure. The slip rings may enable continuous rotation of the motor assemblies while maintaining electrical connectivity for power delivery, data transmission, and control signals. In an embodiment, the first motor assembly may include a first slip ring coupled to the first rotor or the first stator. The first slip ring may be configured to transmit power and/or data signals between the stationary system mount and the rotating components of the universal stabilization system. In some embodiments, the first slip ring may be a hollow bore slip ring that allows cables, optical fibers, or other components to pass through its center opening. In an embodiment, the fourth motor assembly may include a fourth slip ring, and the fifth motor assembly may include a fifth slip ring. The fourth slip ring and the fifth slip ring may be configured to transmit power and/or data signals to payloads coupled to the fourth rotor and the fifth rotor, respectively. In some embodiments, the fourth slip ring and the fifth slip ring may be coupled to the axle that connects the fourth stator to the fifth stator. In an embodiment, the universal stabilization system may include slip rings on the first motor assembly, the fourth motor assembly, and the fifth motor assembly. This configuration may allow for continuous 360-degree rotation of the pan axis (via the first slip ring) and the tilt axis (via the fourth and fifth slip rings) while maintaining electrical connectivity to the payloads. In other embodiments, each of the first motor assembly, the second motor assembly, the third motor assembly, the fourth motor assembly, and the fifth motor assembly may include a corresponding slip ring. This configuration may provide maximum flexibility for power and data transmission throughout the universal stabilization system, regardless of the rotational position of any of the motor assemblies. The slip rings may be configured to transmit various types of signals, including but not limited to power signals for operating the payloads; video signals from cameras or other imaging devices; control signals for adjusting payload settings; data signals from sensors coupled to the payloads; audio signals; network data (e.g., Ethernet); and any combination thereof. In some embodiments, the slip rings may include multiple channels or circuits to accommodate different types of signals simultaneously. In an embodiment, the slip rings may be integrated within the hollow center of the slot-less motors. This configuration may provide a compact design that minimizes the overall size of the universal stabilization system while maintaining full electrical connectivity. The slip rings may be of various types, including but not limited to: pancake slip rings, through-bore slip rings, capsule slip rings, fiber optic rotary joints (FORJs), fluid rotary unions, or hybrid slip rings that combine multiple functionalities. The selection of slip ring type may depend on the specific requirements of the application, such as the number of circuits needed, the data rate required, the rotational speed, and the environmental conditions. FIG. 9B illustrates the details of the slip ring assembly 702 in accordance with the principles of the present disclosure.

The present disclosure provides details on a specific type of universal stabilization system, but one skilled in the art will realize that other types of stabilization systems may also be manufactured using the systems and methods provided in this disclosure.

One or more illustrative embodiments of the disclosure have been described above. The above-described embodiments are merely illustrative of the scope of this disclosure and are not intended to be limiting in any way. Accordingly, variations, modifications, and equivalents of the embodiments disclosed herein are also within the scope of this disclosure.

While the present disclosure has been described with reference to a number of embodiments, it will be understood by those skilled in the art that the invention is not limited to such disclosed embodiments. Rather, the disclosure can be modified to incorporate any number of variations, alterations, substitutions, or equivalent arrangements not described herein, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description but is only limited by the scope of the appended claims.

A number of implementations have been described. Nevertheless, it will be understood that various modifications may be made without departing from the spirit and scope of the disclosure. Accordingly, other implementations are within the scope of the following claims.

1. A universal stabilization system comprising:
a first motor assembly;
a first link member coupled to the first motor assembly;
a second link member coupled to the first motor assembly;
a third link member;
a second motor assembly coupled to the first link member;
a third motor assembly coupled to the second link member;
a fourth motor assembly coupled to the third link member; and
a fifth motor assembly coupled to the third link member.

2. The universal stabilization system of claim 1, wherein:
the first motor assembly includes a first rotor and a first stator;
the second motor assembly includes a second rotor and a second stator;
the third motor assembly includes a third rotor and a third stator;
the fourth motor assembly includes a fourth rotor and a fourth stator; and
the fifth motor assembly includes a fifth rotor and a fifth stator.

3. The universal stabilization system of claim 2, wherein:
the first link member and the second link member are coupled with the first rotor;
the first link member is coupled to the second stator; and
the second link member is coupled to the third stator.

4. The universal stabilization system of claim 2, wherein:
the third link member is connected to the second rotor; and
the third link member is connected to the third rotor.

5. The universal stabilization system of claim 2, wherein:
the third link member is connected to the fourth stator; and
the third link member is connected to the fifth stator.

6. The universal stabilization system of claim 1, wherein the third link member has a first surface, a second surface, a third surface and a fourth surface and wherein:
the first surface is orthogonal to the second surface; the second surface is orthogonal to the third surface; and
the third surface is orthogonal to the fourth surface; and the fourth surface is orthogonal to the first surface.

7. The universal stabilization system of claim 6, wherein:
the first surface is opposite to the third surface; and
the second surface is opposite to the fourth surface.

8. The universal stabilization system of claim 1, further comprising an axle that is coupled between the fourth motor assembly and the fifth motor assembly.

9. The universal stabilization system of claim 1, wherein:
the first motor assembly is configured to rotate around a first axis;
the second motor assembly and the third motor assembly are configured to move along a second axis; and
the fourth motor assembly and the fifth motor assembly are configured to rotate around a third axis, wherein the first axis, the second axis, and the third axis intersect at a point that represents a center of gravity of the universal stabilization system.

10. The universal stabilization system of claim 9, wherein the point is located within the third link member.

11. The universal stabilization system of claim 1, further comprising one or more slip rings coupled to one or more of the motor assemblies, wherein the one or more slip rings are configured to transmit power and electrical signals while enabling continuous rotation of the motor assemblies.

12. The universal stabilization system of claim 11, wherein the one or more slip rings comprise a first slip ring coupled to the first motor assembly, a second slip ring coupled to the fourth motor assembly, and a third slip ring coupled to the fifth motor assembly.

13. The universal stabilization system of claim 11, wherein each of the first motor assembly, the second motor assembly, the third motor assembly, the fourth motor assembly, and the fifth motor assembly includes a corresponding slip ring.

14. The universal stabilization system of claim 1, further comprising a power management system configured to control a power state of one or more of the motor assemblies.

15. The universal stabilization system of claim 14, wherein the power management system includes a power run/stop control for each motor assembly.

16. A system comprising:
a stabilization assembly; and
a payload frame coupled to the stabilization assembly, wherein the stabilization assembly includes:
a first motor assembly;
a first link member coupled to the first motor assembly;
a second link member coupled to the first motor assembly;
a third link member;
a second motor assembly coupled to the first link member;
a third motor assembly coupled to the second link member;
a fourth motor assembly coupled to the third link member; and
a fifth motor assembly coupled to the third link member.

17. The system of claim 16, wherein the payload frame is mounted at the periphery of the stabilization assembly such that the stabilization assembly is disposed at a center of gravity of the system.

18. The system of claim 16, wherein the payload frame is configured to support up to 20 payloads concurrently.

19. The system of claim 16, wherein the payload frame can be adjusted about one or more of:
a first axis, a second axis, and a third axis to achieve payload balance.

20. The system of claim 16, wherein the first motor assembly includes a first rotor and a first stator; the second motor assembly includes a second rotor and a second stator; the third motor assembly includes a third rotor and a third stator; the fourth motor assembly includes a fourth rotor and a fourth stator; and the fifth motor assembly includes a fifth rotor and a fifth stator.

21. The system of claim 19, wherein the first link member and the second link member are coupled with the first rotor; the first link member is coupled to the second stator; and the second link member is coupled to the third stator.

22. The system of claim 19, wherein the third link member is connected to the second rotor;
the third link member is connected to the third rotor; the third link member is connected to the fourth stator; and the third link member is connected to the fifth stator.

23. The system of claim 16, wherein the third link member has a first surface, a second surface, a third surface and a fourth surface and wherein:
the first surface is orthogonal to the second surface;
the second surface is orthogonal to the third surface;
the third surface is orthogonal to the fourth surface; and
the fourth surface is orthogonal to the first surface.

24. The system of claim 23, wherein:
the first surface is opposite to the third surface; and
the second surface is opposite to the fourth surface.

25. The system of claim 16, wherein:
the first motor assembly is configured to rotate around a first axis;
the second motor assembly and the third motor assembly are configured to move along a second axis; and
the fourth motor assembly and the fifth motor assembly are configured to rotate around a third axis, wherein the first axis, the second axis, and the third axis intersect at a point that represents a center of gravity of the system.

26. The system of claim 16, wherein the stabilization assembly further comprises an axle that is coupled between the fourth motor assembly and the fifth motor assembly.

27. The system of claim 16, further comprising a power distribution unit configured to receive power and communication inputs and distribute power and communication signals to each payload connected to the stabilization assembly.

28. The system of claim 16, wherein the payloads comprise one or more military sensor payloads selected from: electro-optical/infrared sensors; forward-looking infrared systems;
multispectral sensors; hyperspectral sensors; LIDAR systems; RADAR systems; signals intelligence sensors; electronic warfare equipment; chemical, biological, radiological, and nuclear sensors; acoustic sensors; or any combination thereof.

29. The system of claim 16, further comprising eight payloads arranged in a pin-wheel configuration wherein each payload is arranged at an angle of 45 degree offset from an adjacent payload.

30. The system of claim 16, further comprising twelve payloads arranged in a toed-in configuration wherein each payload is arranged at an angle of 45 degree offset from an adjacent payload.
